(19) United States
(12) Patent Application Publication
(10) Pub. No.: US 2025/0119750 A1
(43) Pub. Date: Apr. 10, 2025

(54) METHODS, DEVICES AND SYSTEMS FOR SECURING WIRELESS SYSTEMS FROM INSIDER INFORMATION ATTACKS

(71) Applicant: Cypress Semiconductor Corporation, San Jose, CA (US)

(72) Inventors: Abhik Chitta Ghanti, Barddhaman (IN); Vinoth Sampath, Bangalore (IN); Hui Luo, Marlboro, NJ (US); Ramanathan Ramakrishshnan, Bangalore (IN)

(73) Assignee: Cypress Semiconductor Corporation, San Jose, CA (US)

(21) Appl. No.: 18/611,243

(22) Filed: Mar. 20, 2024

Related U.S. Application Data
(60) Provisional application No. 63/543,399, filed on Oct. 10, 2023.

(51) Int. Cl. H04W 12/128; H04W 84/12

(52) U.S. Cl. CPC H04W 12/128; H04W 84/12

(57) ABSTRACT

A method can include, by operation of a first wireless device, storing media access control (MAC) addresses for associated devices in first memory circuits of the first wireless device and receiving a wireless request protocol data unit (PDU) via wireless communication circuits. By operation of controller circuits of the first wireless device, determining if the MAC address of the request PDU matches a stored MAC address, and, in response to at least the MAC address of the request PDU matching a stored MAC address, ignoring the request PDU or not transmitting buffered data corresponding to a destination of the matching MAC address. Corresponding devices and systems are also disclosed.

### RELATED APPLICATIONS

The present application claims the priority and benefit of U.S. Patent Application No. 63/543,399 filed on Oct. 10, 2023, the contents of which are incorporated by reference herein in their entirety.

### TECHNICAL FIELD

The present disclosure relates generally to wireless systems, and more particular to wireless systems that can protect themselves from attacks using insider information, such as the addresses of devices that have already joined the network.

### BACKGROUND

Wireless systems, such as systems compatible with some IEEE 802.11 wireless standards, can be susceptible to attacks using the media access control (MAC) address of a station device (STA) that is already associated with a basic service set (BSS), including a BSS of a distributed system (DS) (i.e., a MAC stealer attack).

One type of MAC stealer attack can override a security context of an associated STA (the “victim” STA). In such an attack, an attacker can disconnect a victim STA from an AP using a variety of methods, including with a de-authentication frame having management frame protection (MFP). The attacker can then connect to the AP using the victim STA MAC address. Such an attack need not require tight timing between attacker messages, as a request from a victim STA could be resent by an endpoint (e.g., HTTP response data by TCP transmission). One example of a security context override attack is shown in FIG. 16.

Referring to FIG. 16, a system 1601 can have an access point device (AP) 1605 that can control access to a BSS. A STA 1603 can join a network using an exchange of association messages 1609. Such a method can include any suitable association methods and authenticate/security steps, including but not limited to Passpoint, promulgated by the Wi-Fi Alliance, WPA-3 (including an Enterprise mode). Such methods can include simultaneous authentication of equals (SAE) public key (SAE-PK) authentication steps.

Once associated, a STA 1603 can issue HTTP requests 1611 for servicing by AP 1605. However, before the HTTP request 1611 can be serviced, an attacker 1608 in possession of the MAC address of STA 1603 can spoof a de-authentication request 1608-0 addressed to STA 1603. An attacker 1608 can then seek connection to AP 1605 using the misappropriated MAC address and its own credentials 1613. The AP 1605 can mistakenly overwrite 1605-0 the security context corresponding to STA 1603 with a new context established and controlled by attacker 1608. An AP 1605 can then mistakenly prepare a response data frame to the HTTP request using the overwritten context and send to the (misappropriated) MAC address of attacker 1605-1. In this way, attacker can acquire downlink data intended for STA 1603.

Another type of MAC stealer attack is a fast reconnection attack. A fast reconnection attack can be aimed at a DS having more than one AP. Assuming a victim STA is connected to a first AP (AP1), an attacker can connect to a second AP (AP2) using the victim STA's MAC address. The DS can then deliver downlink traffic (originally requested by the victim STA) to the attacker via AP2, as a DS can be configured to forward traffic to the AP with whom the MAC address was last authenticated. One example of a fast reconnection attack is shown in FIG. 17.

Referring to FIG. 17, a system 1701 can include a DS 1705 with two APs (AP1 1705-0, AP2 1705-1). A STA 1703 can associate with DP 1705 via AP1 1705-0 with connection and authentication steps 1715. An attacker 1708 can associate with AP2 1705-1 using a spoofed MAC address 1713 (i.e., MAC address of STA 1703). In response, AP2 1705-1 can begin associating with the attacker 1708. In the example shown, this can include association and authentication, including a four-way handshake 1717. AP2 1705-1 can cache a pairwise master key (PMK) negotiated with the attacker 1705-10. AP2 1705-1 can use PMKID to keep track of the PMK associated with the (spoofed) MAC 1721.

STA 1703 can issue a request 1719 to DS 1705 via AP1 1705-0. However, due to the association by attacker 1721, AP2 1705-1 can load the cached PMK (generated with the attacker credentials) 1705-11. A four-way handshake can be executed 1723 between attacker 1706 and AP2 1705-1 to establish encryption keys. Because the attacker's association is the most recent, DS 1705 can transmit a response 1725 (corresponding to request 1719) to attacker 1708 rather than STA 1703.

Any way of preventing or otherwise thwarting such insider information attacks could greatly contribute the security of wireless systems.

### SUMMARY

Embodiments can include methods, devices and systems that include, by operation of a first wireless device, storing MAC addresses for devices associated with a wireless network in first memory circuits of the first wireless device and receiving a wireless request protocol data unit (PDU) via wireless communication circuits. By operation of controller circuits of the first wireless device, determining if the MAC address of the request PDU matches a stored MAC address. In response to at least the MAC address of the request PDU matching a stored MAC address, ignoring the request PDU or not transmitting buffered data corresponding to the matching MAC address of the request PDU.

### BRIEF DESCRIPTION OF THE DRAWINGS

FIG. 1A is a signaling diagram showing a system and corresponding operations according to an embodiment.

FIG. 1B is a continuation of the signaling diagram of FIG. 1A.

FIG. 2 is a signaling diagram showing a system and corresponding operations according to another embodiment.

FIG. 3 is a signaling diagram showing a system and corresponding operations according to a further embodiment.

FIG. 4 is a flow diagram of a method according to an embodiment.

FIG. 5 is a flow diagram of a method according to another embodiment.

FIG. 6 is a flow diagram of a method according to a further embodiment.

FIG. 7 is a flow diagram of a method according to another embodiment.

FIG. 8 is a block diagram of a device according to an embodiment.

FIG. 9 is a block diagram of a device according to an embodiment.

FIG. 10 is a diagram showing memory circuits and stored values according to an embodiment.

FIG. 11 is a block diagram of a device according to another embodiment.

FIG. 12 is a diagram showing a message that can be transmitted from one access control device to another according to an embodiment.

FIG. 13 is a diagram of an integrated circuit device according to an embodiment.

FIG. 14 is a diagram of a vehicle system according to an embodiment.

FIG. 15 is a diagram showing a system with Internet-of-Things (IoT) devices according to an embodiment.

FIG. 16 is a signaling diagram showing a first type insider information attack.

FIG. 17 is a signaling diagram showing a second type insider information attack.

### DETAILED DESCRIPTION

According to embodiments, a wireless network can be protected against attackers having “insider” information, such as a device media access control (MAC) address, as but one example. According to embodiments, a wireless device can compare a device address (e.g., source MAC address) of an incoming request to join a network to that of devices already operating in the wireless network (e.g., associated devices). If there is an address match, the wireless device can ignore further requests to join the network that include the matching address and/or withhold download data scheduled for transmission to the matching address, and eventually dropping such download data.

According to embodiments, a wireless device can utilize information in addition to a device address to distinguish an attacker from a valid device attempting to join a network. In some embodiments, data scheduled for transmission can be scanned for a device address and higher network layer value (e.g., port address). If the device address and higher network layer value do not match those of a device operating on the network, the data scheduled for transmission will not be transmitted. Higher network layer values can be layers above that providing the device address. As but two of many possible examples, a (layer two) MAC address can be device address, while a higher layer value can be a (layer four) port value according to a user datagram protocol (UPD) or transmission control protocol (TCP).

In some embodiments, a wireless device can be an access point device (AP) compatible with at least one IEEE 802.11 wireless standard. An AP can maintain a context for each station device (STA) upon association. Such a context can include a MAC address, one or more source (UDP or TCP) port values, and a timer. The timer can be reset with the receipt of uplink data from a STA. The AP can compare a MAC address and destination port for downlink data to existing contexts. If the MAC address and destination port do not match that of a context, the downlink data can be dropped after a timer expires.

According to embodiments, when a wireless device receives a request to connect to a network from a device address that matches that of an existing connected device, the wireless device can return a response to the requesting device to retry the request at a later time. The wireless device can then query the existing connected device. If a response is received from the existing connected device, further requests to be added to the network by the duplicate device address can be ignored.

In some embodiments, a wireless device can be an AP compatible with an IEEE 802.11 wireless standard. The AP can check the MAC address of an association request to that of existing associated STAs. It is understood that association requests can include re-association requests. If a MAC address match exists, the AP can return an association response to retry the association request (e.g., status code 30). The AP can transmit a probe request (e.g., with a null QoS frame) to the STA. If an ACK to the probe is not received, the AP can ignore further association requests with the matching MAC address.

In some embodiments, a wireless device can be an access control device in a distributed system (DS). When the access control device receives a request to connect to a network, the access control device can request other access control devices in the network to check for devices with a matching address. If such devices are already part of the DS, further requests to be added to the network by the duplicate device address can be ignored.

In some embodiments, a wireless device can be an AP in a DS compatible with an IEEE 802.11 wireless standard. The AP can request other APs in the DS to check for a match in the MAC address of a received association request. Such other APs can query any STAs for matching MAC addresses, as described herein. Upon detecting an associated STA with the matching MAC address, such other APs can return a response to the requesting AP indicating an existing MAC. In response, the requesting AP can ignore further association requests with the matching MAC address.

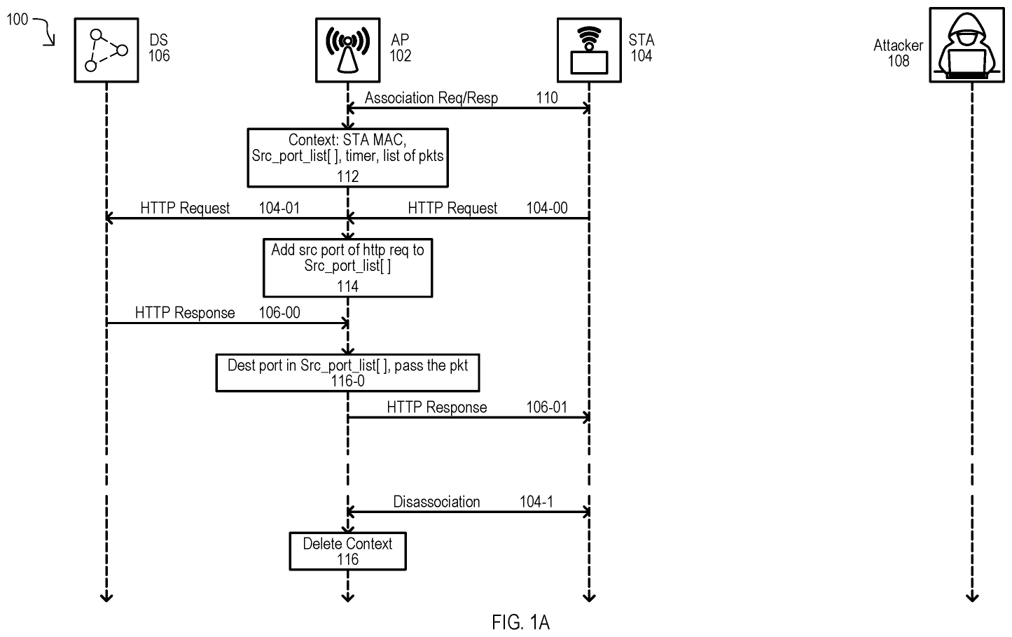

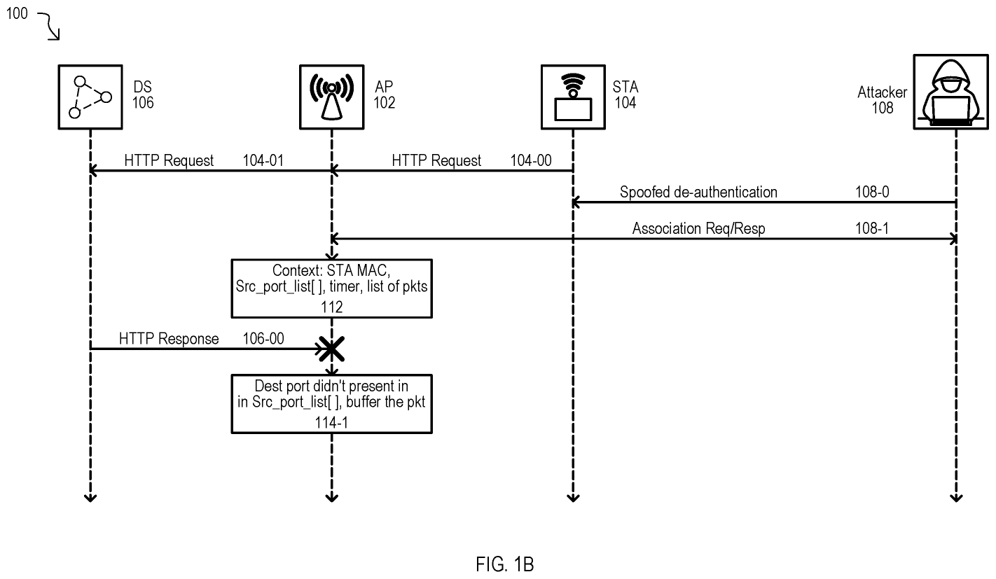

FIGS. 1A and 1B are signaling diagrams showing operations of a system 100 according to an embodiment. A system 100 can include an access point device (AP) 102, a client device (STA) 104, and remaining portions of a DS 106. FIGS. 1A and 1B also show an attacker 108 that is in possession of a device (e.g., MAC) address of STA 104. A system 100 can operate by devices (AP 102, STA 104) transmitting and receiving protocol data units (PDU) according to one or more wireless standards. In some embodiments, a system 100 can be compatible with one or more IEEE 802.11 wireless standards. However, alternate embodiments can include any suitable wireless standards that include a joining stage (e.g., association) that establishes an encryption scheme for network layer values (e.g., layer four port identifiers) above the layer with a device address (e.g., layer two MAC address).

Referring to FIG. 1A, operations of a system 100 will now be described. A STA 104 can execute an association operation 110 with AP 102. Such an action can include any suitable exchange of messages that results in STA 104 being added to the system 100. In some embodiments, association operation 110 can include an authentication operation that can result in STA 104 being capable of encrypting portions of datagrams that are at a higher level network layer than a device address. In some embodiments, devices (AP 102, STA 104) can include MAC addresses, and encrypt data (e.g., port addresses) of higher network layers.

Upon successful association, AP 102 can generate a context corresponding to the STA 104. A context can include values derived or ascertained in the association process, including a device address of STA 104 (e.g., MAC address), as well as higher layer network values (e.g., port addresses). In the embodiment shown, a context 112 can include, but is not limited to a STA MAC address, a source port list (Src_port_list [ ]), a timer, and a list of packets (list of pckts). A source port list can include source port values corresponding to PDUs received from STA 104, and can be updated as new PDUs (e.g., uplink packets) are received. A timer can be used to determine how long a PDU for transmission (e.g., downlink packet) can be held in a buffer before it is dropped. A list of packets can identify and/or locate data held in a buffer for download (e.g., downlink data) that correspond to a given MAC address.

Referring still to FIG. 1A, once STA 104 is associated with the system 100 and AP 102 has established a context for STA 104, requests from STA 104 can be processed. While such requests can take any suitable form, in the embodiment shown, STA 104 can transmit an HTTP request 104-00 which can be received by AP 102 and forwarded 104-01 to other devices in the system 100 which can be other portions of a DS 106. In addition, AP 102 can update a context for STA 104 with a source port value (e.g., add the source port src_port_list) 114.

In response to HTTP request 104-00/01, an HTTP response 106-00 can be returned to AP 102. AP 102 can evaluate the download data for a MAC address and higher network layer value (in this embodiment, a UDP/TCP destination port). In the embodiment shown, the MAC address and source port value match the context for STA 104. Accordingly, HTTP response 106-01 can be forwarded to STA 104. In some embodiments, an AP 102 can buffer download data having a MAC address matching that of an existing context. Higher network layer values can then be evaluated. If a MAC address and destination port of HTTP response 106-00 do not match a MAC address and source port for a context, a timer for the context can be started. Upon expiration of the timer, download data can be dropped (e.g., deleted, overwritten, etc.).

FIG. 1A also shows operations when a device is removed from the network (e.g., disassociated). In response to a messages from AP 102 or STA 104, STA 104 can be removed from the network. In response, AP 102 can delete the context associated with STA 116.

FIG. 1B shows operations of system 100 of FIG. 1A in response to an attempt to access data by an attacker 108 in possession of the MAC address for STA 104. STA 104 can make an HTTP request 104-00/01 as described for FIG. 1A. However, unlike FIG. 1A, attacker 108 can spoof a de-authentication message to STA 104, causing STA 104 to determine it is no longer authenticated to the system 100. Attacker 108 can then execute an association operation 108-1 with AP 102, using the MAC address of STA 104. As described for FIG. 1A, in response to the association operation 108-1, AP 102 can update a context 112 for the MAC address being used by attacker 108. However, because higher network layer values (e.g., source port) are encrypted, an attacker 108 source port will almost certainly differ from that of the HTTP request 104-00/01 from STA 104.

When an HTTP response 106-00 corresponding to the HTTP request 104-00/01 by STA 104 is received at AP 102, AP 102 can examine the MAC address and destination port, and because such values do not match the current context, the downlink data can be held in the buffer 114-1, and the timer started. If the timer expires, the download packet is dropped, preventing attacker 108 from surreptitiously receiving the data.

In this way, a device controlling access to a network, such as an AP, can maintain context on connected devices that includes a device address and higher network layer values. Such contexts can be updated with each received communication from connected devices. When data for download is received that does not match a context, the data can be held and eventually dropped.

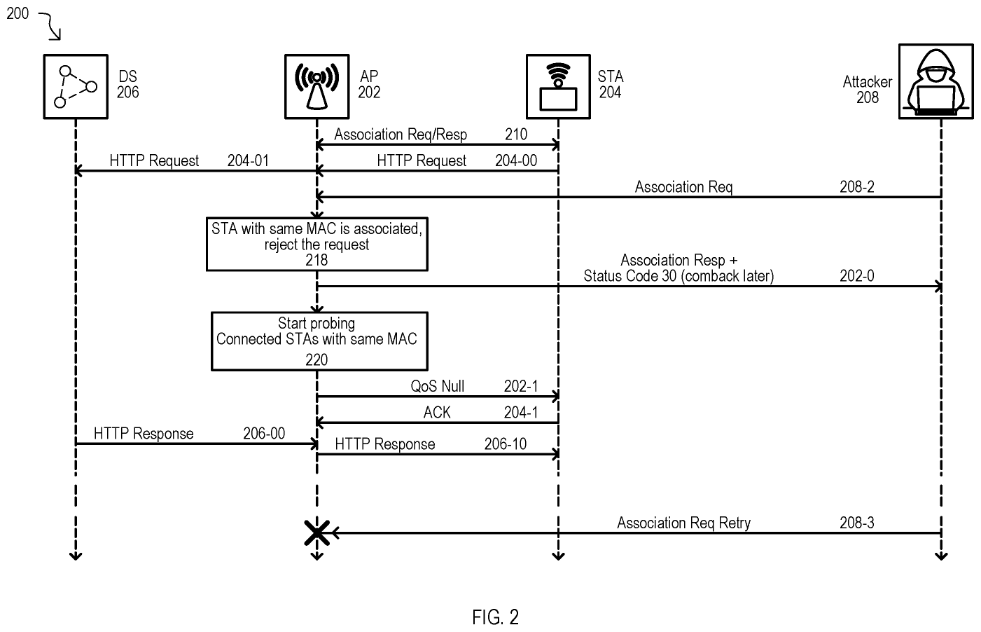

FIG. 2 is a signaling diagram showing operations of a system 200 according to another embodiment. A system 200 can include items like those of FIGS. 1A/B, and such like items are shown with the same reference characters but with the leading digit being a “2” instead of a “1”. Operations of system 200 will now be described.

A STA 204 can execute an association operation with AP 202. Such an association operation can take the form of any of those described herein or equivalents. Once associated, STA 204 can make requests (e.g., HTTP requests 204-00/01) to a system that elicit response data.

In the embodiment shown, attacker 208 is in possession of the device address (e.g., MAC address) of STA 204, and requests association 208-2 with the system 200 using such a MAC address. In response to the association request, AP 202 can determine if the MAC address of the association request matches that of an existing associated device. Such an operation can include AP 202 accessing memory circuits to determine if the device address matches a stored device address. If a STA with the same MAC address is determined to already be associated, by a matching MAC address in memory, the request can be initially rejected 218. In some embodiments, such a rejection can include AP 202 indicating to the requesting device that it should retry the request at a later time 202-0. In the embodiment shown, a system can be compatible with an IEEE 802.11 wireless standard, and AP 202 can return an association response with a status code 30, indicating the requesting device (i.e., attacker 208) should come back later and retry association.

Having determined that a STA with a same MAC address as an association request exists, AP 202 can determine if a STA with the same MAC address is currently active. In the embodiment shown, such an action can include probing connected STAs (including STA 204 which possesses the matching MAC address) for a response 220. In the embodiment shown, such an action can include issuing a quality-of-service (QOS) null data frame 202-1. However, alternate embodiments can include any other suitable message from an AP that elicits a response that includes a STA device address (e.g., MAC address).

In response to the probe by AP 202, STA 204 can return a message indicating it is still associated with the system 200. In the embodiment shown, such a message can be an acknowledgment (ACK) 204-1 of the QoS null data frame 202-1.

From such an acknowledgement, AP 202 can determine that association requests for the corresponding MAC address are not valid. When download data for the MAC address are received (e.g., HTTP response 206-00), AP 202 can forward such data to STA 204 (e.g., HTTP response 206-01).

If attacker 208 retries an association request 208-3 using the MAC address of STA 204, AP 202 can ignore such a request 222.

In this way, an access control device for a network can determine if a request to join the network has a device address that matches that of a device that is already part of the network. If such a match exists, an access control device can refuse the request to join, and determine if the device with the matching device address is still active on the network. If the device is still active, further requests to join the network using the matching device address can be ignored.

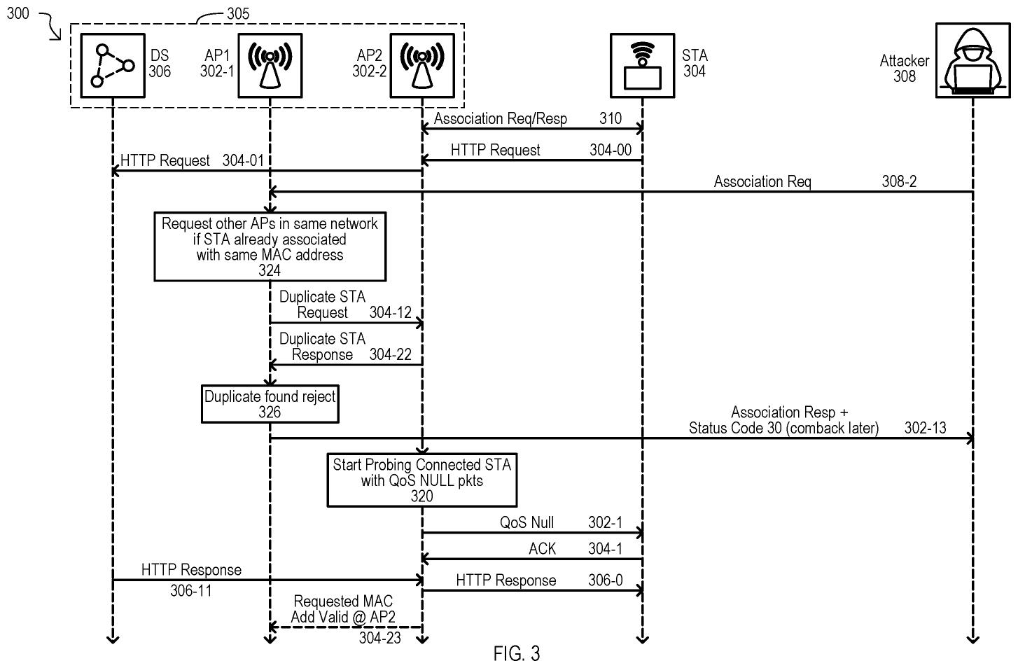

FIG. 3 is a signaling diagram showing operations of a system 300 according to a further embodiment. A system 300 can include items like those of FIGS. 1A/B, and such like items are shown with the same reference characters but with the leading digit being a “3” instead of a “1”. However, unlike FIG. 1A/B, two APs are shown AP1 302-1 and AP2 302-2. In some embodiments, AP1 302-1 can control one basic service set (BSS), while AP2 302-2 can control another BSS, with the two BSSs being part of a same DS 305. Operations of system 300 will now be described.

A STA 304 can execute an association operation with AP2 310. Such an association operation can take the form of any of those described herein or equivalents. Once associated, STA 304 can make requests 304-00/01 to a system intended to elicit response data.

In the embodiment shown, attacker 308 is in possession of the device address of STA 304, and requests association 308-2 with a different BSS (i.e., that of AP1 302-1) using such a MAC address. In response to the association request, AP1 302-1 can make a request to other APs in the network to determine if such other APs are already associated with a STA having the same device address (MAC address) 324. Such a request from AP1 302-1 to AP2 302-2 is shown as 304-12.

In response to request 304-12 from AP1 302-1, AP2 302-2 can return a response 304-22 that the indicated device address matches an associated device 326 (e.g., MAC address of attacker association request 308-2 matches that of STA 304). From such a response 304-22, AP1 302-1 can determine that a device address duplicate has been found, and can reject the request (from attacker 308). Such a rejection can include any of those described herein, including but not limited to, the transmission of an association response with a status code (e.g., status code 30) 302-13.

Having determined a STA with a same MAC address as an association request exists, AP2 302-2 can determine if STA 304 is currently active. Such actions can include any of those described herein, or equivalents. In the embodiment shown, such an action can include those described in FIG. 2, including probing with QoS null data frame 320 and receiving an ACK 304-1 from STA 304.

In some embodiments, AP2 302-2 can send a message to requesting AP 302-1 indicating that a STA with a matching device is still active 304-23. AP1 302-1 can reject all further association requests with the matching device address.

In this way, upon receiving a request to join a network, an access control device can query other access devices of the network to determine if a device that is already part of the network has an address that matches that of the request. If such a match exists, an access control device can refuse the request to join and ignore further requests to join having the matching device address.

While the systems and devices described herein show various methods, additional methods will now be described with reference to flow diagrams. Such methods can be executed by circuits of devices and/or systems described herein.

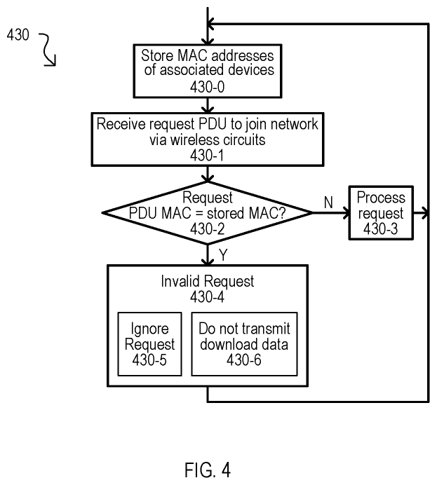

FIG. 4 is a flow diagram of a method 430 according to an embodiment. A method 430 can be executed by an access control device that can control access to a network, including but not limited to an AP. A method 430 can include storing MAC addresses of associated devices 430-0. A request PDU to join a network can be received via wireless circuits 430-1. Such an action can include receiving a request PDU according to any suitable wireless standard, including but not limited to one or more IEEE 802.11 wireless standards.

If a request PDU does not includes a MAC address of an associated device (N from 430-2), a method 430 can process the request according to the governing standard 430-3. If a request PDU includes a MAC address of an associated device (Y from 430-2), a method 430 can process the request as an invalid request 430-4.

According to embodiments, such actions can include, but are not limited to, ignoring the request 430-5 and/or not transmitting download data targeted to the matching MAC address 430-6.

In this way, when a request to join a network is received, a MAC address of the request can be compared to MAC addresses of devices already associated with the network. If a match is found, the request can be determined to be invalid.

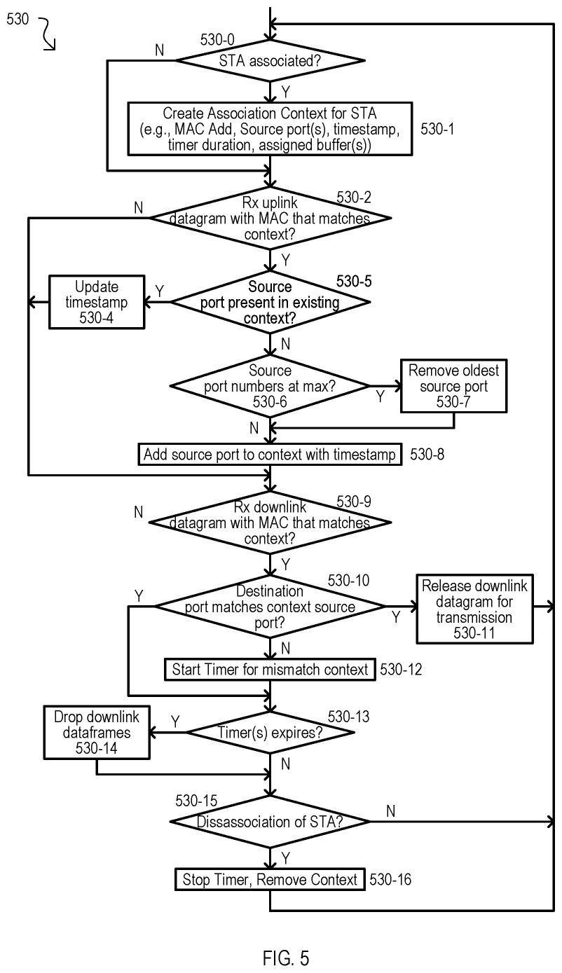

FIG. 5 is a flow diagram of a method 530 according to another embodiment. A method 530 can be executed by a device that controls access to a wireless network. In some embodiments, a method 530 can be executed by an AP to prevent attacks using insider information (e.g., a MAC address of an associated STA). In some embodiments, a method 530 can be executed by an AP operating according to one or more IEEE 802.11 wireless standards.

A method 530 can include determining if a STA has been associated with the network 530-0. Such an action can include completing an association procedure that includes establishing an encryption scheme that ensures encryption of network layers above layer 2, including the encryption of layer 4 values, such as UDP and/or TCP source port values.

A method 530 can create a context for the associated device 530-1. Such an action can include any of those described herein or equivalents. In the embodiment shown, a context for each associated device can include a MAC address, source port, timestamp, timer duration and assigned buffer(s). A timestamp can indicate an age of the context. In some embodiments, contexts can have limited lifetimes, and if a predetermined amount of time has passed since the timestamp, the context can be deleted. A timer duration can indicate an amount of time before a timer for the context expires. Operation of such timers will be described below. Assigned buffer(s) can indicate a location of a buffer for data corresponding to the MAC address, including but not limited to downlink data intended for transmission to a STA corresponding to the context.

A method 530 can determine if an uplink data frame is received with a MAC address matching that of a context 530-2. Such an action can include determining a source MAC address for the uplink data frame and comparing it to MAC addresses of existing contexts. If such an uplink data frame is received (Y from 530-2), a method 530 can determine if the context of the matching MAC address includes a source port matching that of the uplink data frame 530-3. If the source port is already present in the context (Y from 530-3), a timestamp for the context can be updated 530-4. If the source port is not already present in the context (N from 530-3), a method 530 can determine if the context has a maximum number of source ports 530-6. If a context has a maximum number of source ports (Y from 530-6), an oldest source port can be deleted from the context 530-7. In some embodiments, such an action can include deleting a source port value with the oldest timestamp. If a number of source ports is not at a maximum (N from 530-6) or an oldest source port value has been deleted 530-7, a method 530 can add the source port to the context along with a current timestamp 530-8.

A method 530 can determine if a downlink data frame is received with a MAC address matching that of a context 530-9. Such an action can include determining a destination MAC address for the downlink data frame and comparing it to MAC addresses of existing contexts. If such a downlink data frame is received (Y from 530-9), a method 530 can determine if the context of the matching MAC address includes a source port matching a destination port of the downlink data frame 530-10. If the port values match (Y from 530-10), a method can release the downlink data frame for transmission 530-11. If a destination port does not match a source port (N from 530-10), a timer can be started for the context 530-12. If a downlink data frame is received that does not match a context (N from 530-9), a method 530 can drop the downlink dataframe 530-14.

A method 530 can determine if any context timers have expired 530-13. Such an action can include comparing a timer value for a context to its timer duration (or timer value common to all contexts). If a timer has expired (Y from 530-13), the corresponding downlink data frames can be dropped 530-14.

A method 530 can determine if a STA has become disassociated from the network 530-15. Such an action can include any suitable actions compatible with a given wireless standard, including but not limited to, a STA requesting disassociation or an AP forcing disassociation. Upon disassociation of a STA (Y from 530-15), the timer for the context can be stopped and the context can be deleted 530-16.

In this way, a MAC address and port for downlink data can be scanned for a match with an existing, associated device. If there is a MAC address match, but port mismatch, the downlink data can be retained, and eventually dropped.

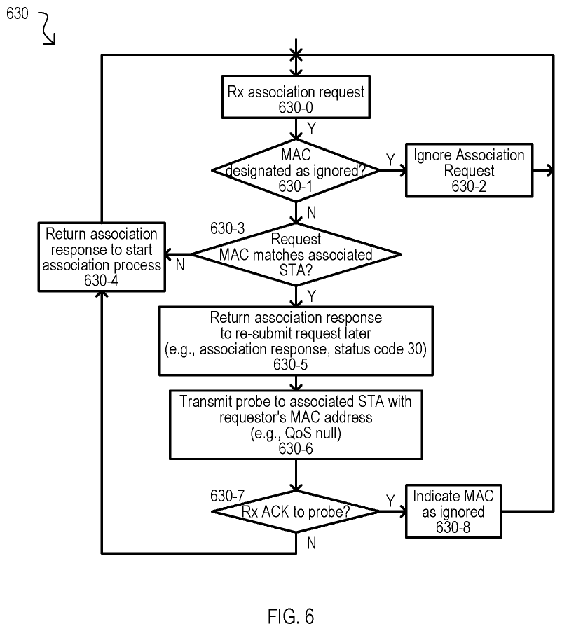

FIG. 6 is a flow diagram of a method 630 according to another embodiment. A method 630 can be executed by a device that controls access to a network. In some embodiments, a method can be executed by an AP to prevent attacks using the device address (MAC) of a device that is already part of the network.

A method 630 can include receiving an association request 630-0. Such an action can include receiving a wireless message to join a network according to any suitable protocol, and in the embodiment shown can be an association request compatible with one or more IEEE 802.11 standards.

A method 630 can determine if a device address (e.g., MAC address) is designated as an address that should be ignored 630-1. How device addresses are determined to be ignored will be described in more detail below. If a device address of a request is designated as ignored (Y from 630-1), the request can be ignored 630-2.

If a device address is not indicated as ignored (N from 630-1), a method 630 can determine if a device address of the association request matches that of a device already connected to the network 630-3. In the embodiment shown, such an action can include determining if a source MAC address of an association request matches the MAC address of a STA that is already associated with the network. If there is no currently associated device with an address that matches that of the association request (N from 630-1), a method 630 can return an association response to start an association process 630-4. Such an action can include proceeding with the appropriate process to add (or possibly not add) the requesting device to the network.

If there is an associated device with a device address that matches that of the association request (Y from 630-1), a method 630 can return a response to the request to re-submit the request at a later time 630-5. In some embodiments, such an action can include an AP transmitting an association response with a status code 30. In addition, messages can be sent to currently associated devices to elicit a response 630-6. In the embodiment shown, such an action can include sending QoS null data probe to the associated STA that has a MAC address that matches the association request. If a response is received from a probe message (Y from 630-7), the device address can be indicated as to be ignored 630-8. If a response is not received from probe message (N from 630-7), a method 630 can proceed with an association process 630-4. In some embodiments, such an action can be preceded by a timeout period, or require more than one association request.

In this way, if an association request includes a device address that matches a currently associated device, a query can be made to determine of the currently associated device is still active. If the associated device responds, the association request can be ignored.

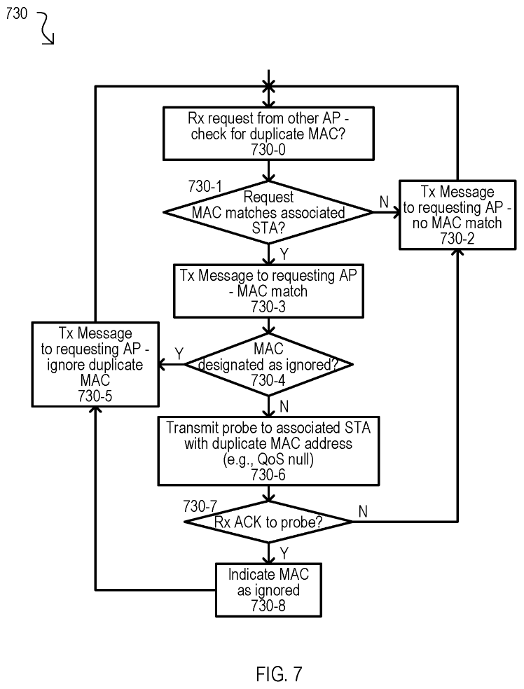

FIG. 7 is a flow diagram of a method 730 according to a further embodiment. A method 730 can be executed by an access control device (e.g., AP) that operates in conjunction with one or more other access control devices to create a larger DS. In some embodiments, a method 730 can be executed by an AP of one BSS that is in communication with another AP of a different BSS, where the two BSSs are part of a same DS.

A method 730 can include receiving a message from another device requesting a check for a duplicate device address 730-0. In some embodiments, such an action can include receiving a message from another AP of a same system (e.g., DS) that includes a MAC address of an association request. A device address identified by the message can be compared to those of associated devices 730-1. In the embodiment shown, this can include determining if a MAC matches that of an associated STA. If a match it not found (N from 730-1), a method 730 can transmit a message to the requesting device that no match was found 730-2.

If a device address received in the message matches that of an existing device (Y from 730-1), a method 730 can transmit a message to the requesting device that a matching device was found 730-3. A method 730-4 can determine if a matching device address is designated as ignored 730-4. If the device address is indicated as one to be ignored (Y from 730-4), a message can be transmitted to the requesting device that the duplicate device address should be ignored 730-5.

If the device address is not indicated as one to be ignored (N from 730-4), a method 730 can proceed as shown in FIG. 6: send probe messages to elicit a response 730-6, and if a response is received (Y from 730-7), indicate the device address as to be ignored 730-8. If a response is not received (N from 730-7), a method 730 can transmit a message indicating no match with a device address 730-2.

In this way, a device that controls access to a network can receive a request from another such device to check if any associated devices match a device address. A message can be returned indicating whether such a matching device address has been found. In addition, if a match is found, the device indicate that requests to join the network having such a matching device address can be ignored.

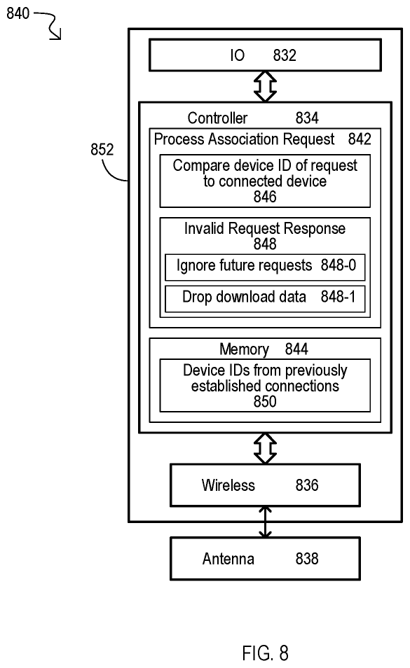

FIG. 8 is a block diagram of a wireless device 840 according to an embodiment. A wireless device 840 can control access to a network. In some embodiments, a device 840 can be an AP of a network, including an AP in a BSS compatible with one or more IEEE 802.11 wireless standards. A device 840 can include input/output (IO) circuits 832, controller circuits 834 and wireless circuits 836. IO circuits 832 can enable a device 840 to communicate with other systems and/or a user, and can include any suitable communication circuits and/or interfaces, including wired and/or wireless circuits/interfaces.

Controller circuits 834 can include any suitable circuits for executing wireless network access operations as described herein, and equivalents. Controller circuits 834 can include, but are not limited to one or more processors, custom logic circuits, programmable logic circuits and/or machine learned/learning systems. Controller circuits 834 can include circuits for processing association requests 842 as well as memory circuits 844 for storing various forms of data. Operations for processing an association request 842 can include comparing a device ID of a request to existing connected devices 846. Such an action can include extracting a device ID from an association request PDU and comparing such a value to device IDs store in memory circuits 844. Processing an association request 842 can also include an invalid request response 848. Such operations can include ignoring future requests from a matching device ID 848-0 and/or dropping download data related to a matching device ID (i.e., not transmitting such data). Memory circuits 844 can store any suitable data for operations of a device 840, including but not limited to device IDs from previously connected devices 850.

Wireless circuits 836 can include circuits compatible with one or more standards, including public and/or private standards. In some embodiments, wireless circuits 836 can be compatible with one or more IEEE 802.11 or related standards. Wireless circuits 836 can be connected to an antenna system 838.

In some embodiments, IO circuits 832, controller circuits 834, and wireless circuits 836 can be part of a same integrated circuit substrate 852.

In this way, a wireless device can include circuits for comparing a device ID present in a request to join a network. If such a device ID matches that of a device that has previously made a connection to the network, the device can ignore the request to join the network and/or drop download data associated with the matching device ID.

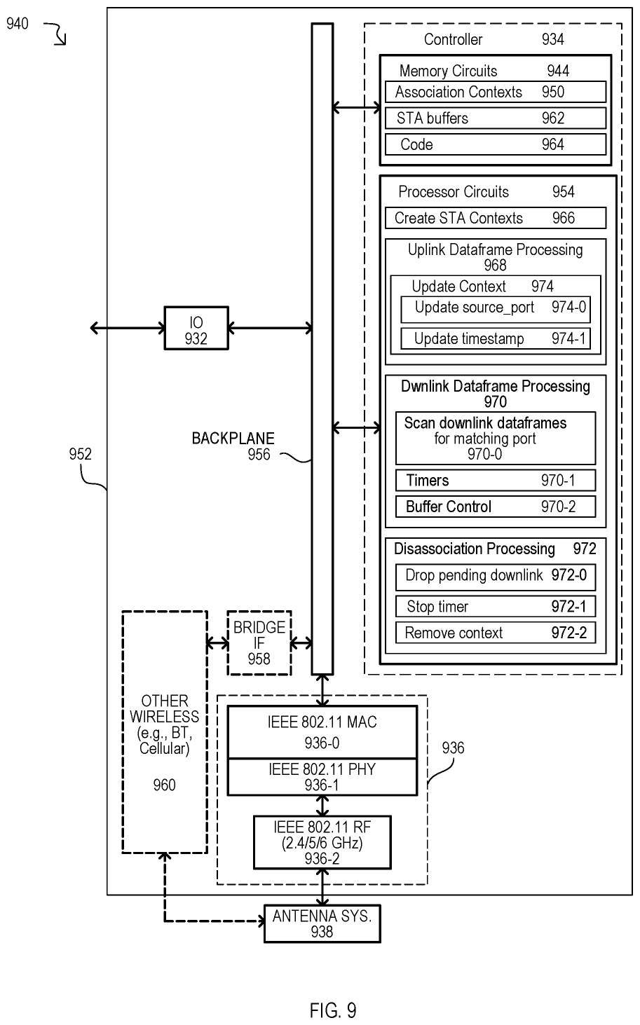

FIG. 9 is a block diagram of a device 940 according to another embodiment. In some embodiments, a device 940 can be an AP or part of an AP that can process association requests by STAs to join a network. A device 940 can include controller circuits 934, Wi-Fi circuits 936, and optionally, other wireless circuits 960 and bridge circuits 958 connected to one another over a backplane and/or bus 956.

A controller circuits 934 can include memory circuits 944 and processor circuits 954. Memory circuits 944 can include any suitable memory circuits, including nonvolatile memory, volatile memory, and/or combinations thereof. In some embodiments, memory circuits 944 can include memory circuits that part of the device 940 can/or memory circuits external to a device 940 but accessible by processor circuits according to a wired or wireless protocol.

Memory circuits 944 can store data for enabling the various operations of wireless device 940, including data for association contexts 950, buffers for downlink data and uplink data for STAs 962, and code (e.g., firmware) 964 executable by processor circuits 954 to provide the various processor circuits operations described herein. Data for association contexts 950 can be created upon successful association by a STA, as described for embodiments herein. In some embodiments, an association context 950 for each associated STA can include a MAC address, higher network layer value (e.g., source port), and other information.

Processor circuits 954 can execute code 964 stored in memory circuits 944 to provide various functions for the device 940. Operations provided by processor circuits 954 can include, but are not limited to, creating STA contexts 966, uplink data frame processing 968, downlink data frame processing 970, and disassociation processing 972. Creating STA contexts 966, can include processing circuits storing a context data in memory circuits 944, as described herein, or equivalents. Such an action can include decrypting portions of a PDU received from a STA to derive the other information.

Uplink data frame processing 968 can include updating a context in response to receiving an uplink data frame 974. Such operations can include updating context values stored in memory circuits 944. In some embodiments, such operations can update a value corresponding to a higher network layer value than a device ID (e.g., layer 4 source port) 974-0 as well as update a timestamp value 974-1.

Downlink data frame processing 970 can include scanning downlink data frames 970-0, executing timers 970-1 and controlling buffers 970-2. Scanning downlink data frames 970-0 can include scanning for network layer values at a higher than a device ID (e.g., layer 4 destination port). A timer 970-1 can be activated for a context in the event a device ID (e.g., MAC address) matches that of a context, but a higher layer value for the downlink data frame does not match that of the same context (e.g., downlink destination port does not match context source port). Buffer control 970-2 can include buffering downlink data frames for contexts (e.g., associated devices), and dropping such downlink data frames in the event a corresponding timer expires (e.g., reaches a predetermined limit).

Disassociation processing 972 can process disassociation requests from associated devices. Such operations can include, upon successful disassociation of a device, dropping any downlink data frames for the disassociated device 972-0, stop any corresponding timer 972-1 and remove (e.g., delete) the context 972-2 for the disassociated device.

Wireless circuits 936 can provide wireless communications compatible with one or more wireless standards. In the embodiment shown, wireless circuits can be compatible with one or more IEEE 802.11 wireless standards. Wireless circuits 936 can include MAC layer circuits 936-0, physical layer (PHY) circuits 936-1, and RF circuits 936-2. Such circuits (936-0,-1,-2) can be compatible with one or more IEEE 802.11 wireless standards, on any suitable band, including but not limited to the 2.4 GHz, 5 GHz and/or 6 GHz bands.

IO circuits 932 can input or output signals that can enable control of a device 940 from sources external to the device according to any suitable fashion. In some embodiments, IO circuits 932 can include serial communication circuits, including but not limited to interfaces compatible with a serial digital interface (SDI), universal serial bus (USB), universal asynchronous receiver transmitter (UART), 12C, or 12S.

Bridge interface circuits 958 can enable communications between wireless circuits 936 and other wireless circuits 960. In some embodiments, such communications can control which wireless circuits (936 or 960) control a shared medium (e.g., 2.4 GHz band).

Other wireless circuits 960 can be one or more wireless circuits compatible with standard other than an IEEE wireless standard, including but not limited to, one or more BT standards, one or more IEEE 802.15.4 or related standards and/or one or more cellular network standards.

A device 940 can operate in conjunction with an antenna system 938 having one or more antennas compatible with one or more wireless, including those of other wireless section 960, if included.

In some embodiments, IO circuits 932, controller section 934, and wireless circuits 936 can be formed with a same integrated circuit substrate 952.

In this way, a wireless device can scan downlink data for a device (e.g., MAC) address and a higher layer value (e.g., destination port) and then compare such values to data stored for each device associated with a network. If a device value matches but a higher layer value does not, the downlink data can be withheld (e.g., not transmitted), and eventually dropped. If a device value and higher layer value match that of a context, the downlink data can be transmitted. In response to uplink data, a context data for a device can be updated (e.g., update source port).

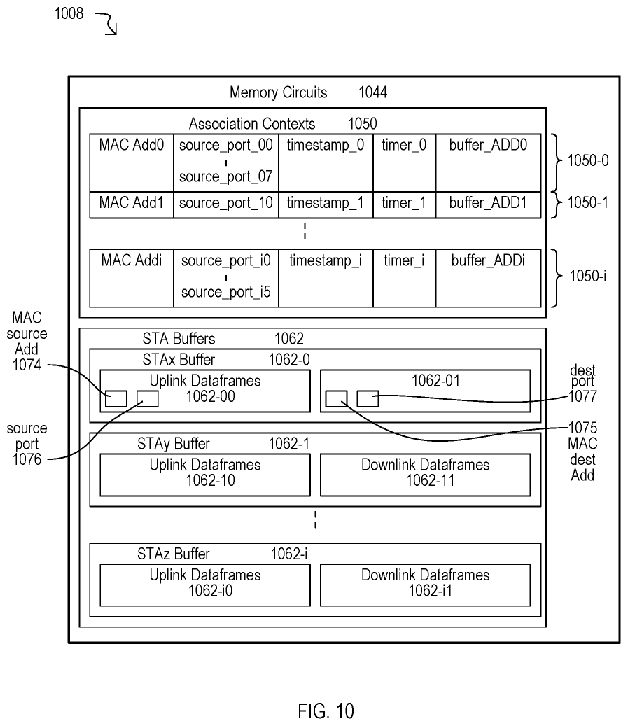

FIG. 10 is a diagram of memory circuits 1044 according to an embodiment. Memory circuits 1044 can be one implementation of those shown in FIG. 8 (844) and/or FIG. 9 (944). Memory circuits 1044 can store association contexts 1050 and include buffers 1062 corresponding to each such context. Association contexts 1050 can include data values for each device that is associated with a network. In the embodiment shown, context data sets for different associated devices are shown as 1050-0 to 1050-i. Each context data set (1050-0 to -i) can include a MAC address (MAC Add0 to MAC Addi), one or more source port addresses (source_port_xx, where xx corresponds to a different source port), a timestamp value (timestamp_0 to timestamp_i), a timer value (timer_0 to time_i), and a buffer address (buffer_ADD0 to buffer_ADDi).

There can be one or more source port values (source_port_xx) per device context. In some embodiments, multiple source port values can be ordered based on time stored (e.g., timestamp). In some embodiments, there can be a maximum number of source port values per context. When a context has such a maximum number of source port values, when a new source port value is to be added, the oldest source port value can be dropped. Alternate embodiments can include a different value at a higher network layer than a MAC address (e.g., higher than layer 2).

A timer value (timer_0 to i) can determine how long downlink data can be stored in a buffer in response to a context mismatch. In some embodiments, each downlink data set (e.g., data frame for transmission to a STA) can be scanned for a

MAC destination address and destination port value. Such values can be compared to MAC addresses and source port values for each context. If there is a MAC address match, but a destination-source port mismatch, a timer can be started for the downlink data. If the timer expires, the downlink data can be dropped (e.g., overwritten, erased, link/pointer value determined to no longer be valid).

Buffer addresses (buffer_ADD0 to ADDi) can indicate where downlink data corresponding to the MAC address of the context (1050-0 to i) are stored. Such values can take any suitable form, including but not limited to, a physical address, logical address, pointer or start of a linked list.

Buffers 1062 can include storage locations for at least downlink data corresponding to the MAC address of each context (1050-0 to -i). In the embodiment shown, buffers 1062 can include storage for buffering data for uplink data frames (1062-00 to -i0) and downlink data frames (1062-01 to -i1). Received uplink data frames (1062-00 to -i0) can be scanned for a source MAC address (e.g., 1074) and source port (e.g., 1076). Such action can include processor or equivalent circuits, reading predetermined locations in a buffer. If a source MAC address (e.g., 1074) of an uplink data frame (1062-00 to -i0) matches that of a context (1050-0 to -i), the source port values can be compared. If such source port values match, a timestamp value can be updated for the context. If such source port values do not match, a source port value for the context can be updated.

Downlink data frames (1062-01 to -i1) can be scanned for a destination MAC address (e.g., 1075) and destination port (e.g., 1077). If a destination MAC address (e.g., 1075) of a downlink data frame (1062-01 to -i1) matches that of a context (1050-0 to -i), the destination port value 1077 can be compared to a source port value (source_port XX) of the corresponding context. If such port values do not match, a timer can be started. In some embodiments, such a timer can be based on a timer value (timer_0 to -i) of the corresponding context (1050-0 to -i).

In this way, a context can be established for STAs upon association to a network. Such contexts can include a MAC address and source port address. When an uplink data frame from an associated STA is received, a source port value of the context can be updated. When a downlink data frame for an associated STA is ready, a destination port of the downlink data frame can be compared to the source port value of the corresponding context. If such values do not match, the downlink data frame may not be transmitted, and can be dropped after a timer expires.

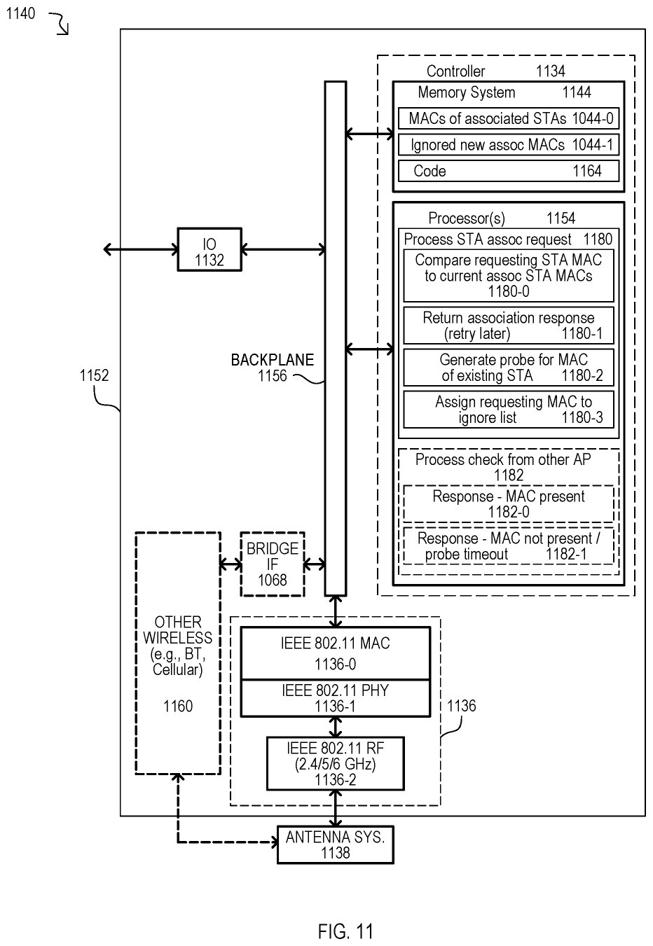

FIG. 11 is a block diagram of a device 1140 according to a further embodiment. A device 1140 can include items like those of FIG. 9, such like items are referred to by the same reference character but with the leading digits being “11” instead of “9”. Memory circuits 1144 can store device (MAC) addresses of associated devices (e.g., STAs) 1144-0. In the embodiment shown, memory circuits 1144 can store device addresses of devices that have been determined to be ignored 1144-1 and code 1164.

Processor circuits 1154 process association requests 1180 and optionally process check requests from other APs 1182. Processing association requests 1180 can include comparing a device address of requesting device to device addresses of already associated devices (e.g., compare request source MAC address to associated device MAC addresses) 1180-0. In the event a requesting device address matches that of an existing associated device, processor circuits 1154 can execute various operations 1180-1, 1180-2 and 1180-3. Operation 1180-1 can include returning an association response that indicates a device should retry later.

In some embodiments, this can include an association response compatible with one or more IEEE 802.11 wireless standards that includes a status code 30. Operation 1180-2 can include generating a probe request directed to the associated device with a matching device address. Such an action can query to determine if the associated device is still active on the network. If a response to a probe is received, indicating the associated device with a matching device address is still active, operations can include assigning the request device address to an ignore list 1180-3.

Optionally, a device 1140 can operate in a distributed system, receiving check requests from other access devices (e.g., APs) 1182. Such operations can include analyzing received data frames from a validated/authenticated AP, and deriving device address from such a request. In the case one of the stored device addresses 1044-0 matches that included in the request from another access device, operations can include returning a response that device address corresponds to an associated device 1182-0. If none of the stored device addresses 1044-0 matches that included in the request, a response can be returned that indicates no such match 1182-1.

In this way, a wireless device can compare a device address in a request to associate with those of already associated devices. If such a match exists, the wireless device can return a response to retry the association request. If an associated device with a matching address is still active on the network, the wireless device can ignore future association requests using such a device address.

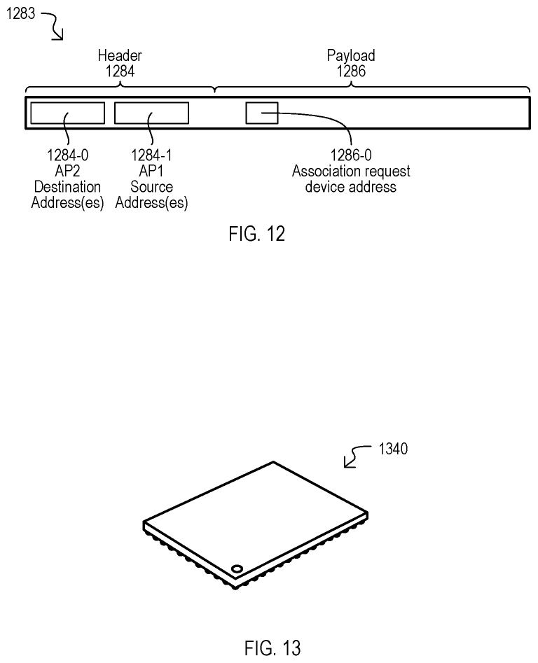

FIG. 12 is a diagram of a message 1283 that can be transmitted between two network access devices to check for a duplicate device address. In the embodiment shown, a message 1283 can include source address(es) 1284-1 of an AP requesting for a check, as well as the destination address(es) 1284-0 of the AP intended to receive the message. A payload 1286 of the message can include the device address (e.g., MAC address) that is to be checked (i.e., determine if the device address matches that of an already associated device).

In this way, AP to AP communications can include a request to check for a MAC address matching that of a STA making an association request.

While embodiments can include systems and devices with various interconnected components, embodiments can also include unitary devices having the ability to protect wireless networks against attacks that utilize a device address of a device already associated with the network. FIG. 13 show one example of a packaged single chip wireless device 1340 according to an embodiment. Such a device 1340 can include circuits for executing device address checking operations as described herein and equivalents. In some embodiments, a device 1340 can include circuits like those shown in any of those shown in FIGS. 8 to 11.

However, it is understood that a device according to embodiments can include any other suitable integrated circuit packaging type, as well as direct bonding of a device chip onto a circuit board or substrate.

In this way, a wireless device that can protect against insider attacks can be included in a single integrated circuit device.

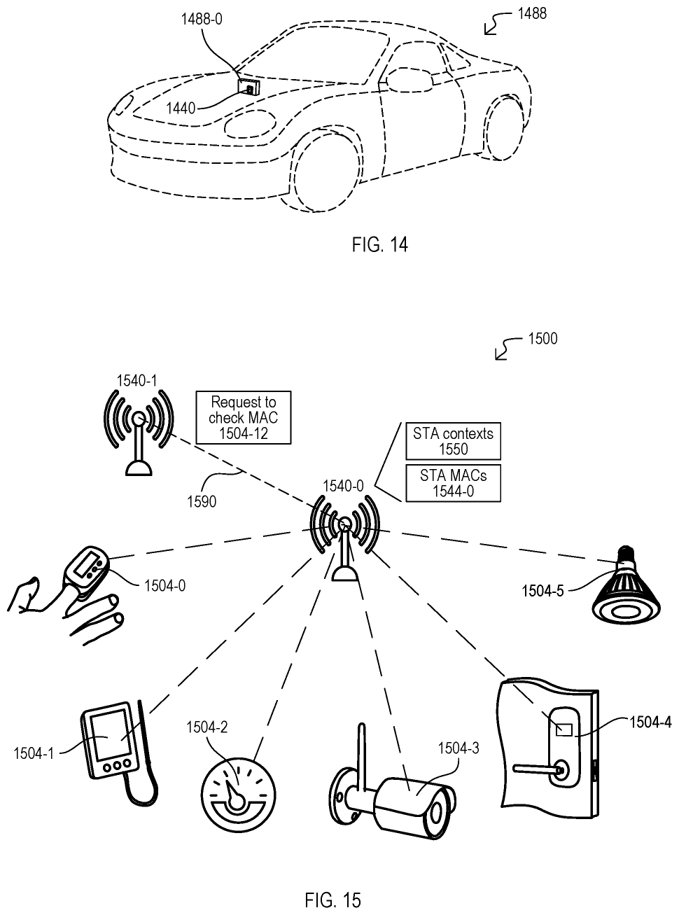

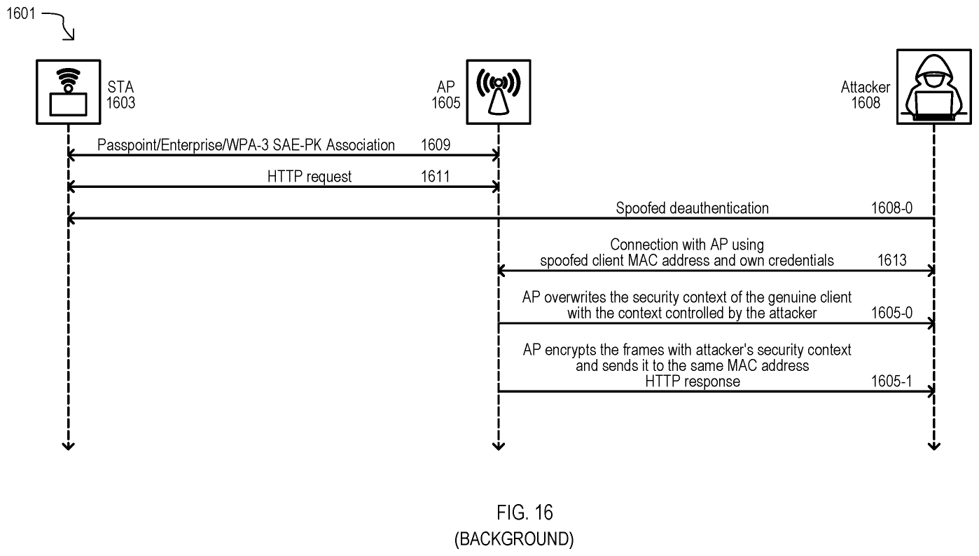

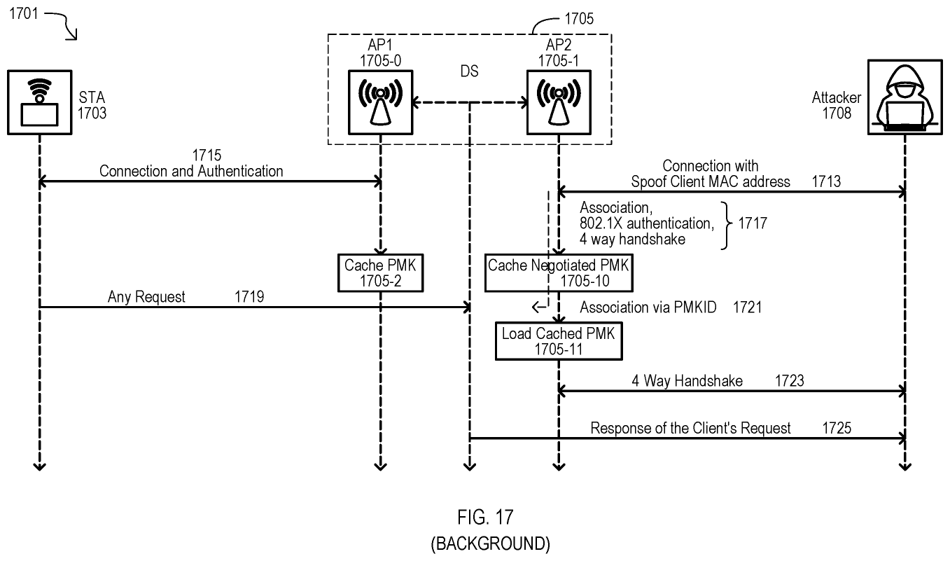

While embodiments can enjoy wide application in various wireless systems, vehicle systems can benefit from the resistance to insider information attacks as described herein. FIG. 14 shows a motor vehicle system 1488 according to an embodiment. A motor vehicle system 1488 can include one or more subsystems 1488-0 (e.g., in-vehicle infotainment system) that can include a wireless device 1440 in the form of any of those described herein, or equivalents.

In this way, vehicles can include a vehicle wireless system that can prevent insider information attacks that utilize addresses of devices already associated with the vehicle wireless system.

FIG. 15 shows a system 1500 according to another embodiment. A system 1500 can include two or more APs 1540-0, 1540-1 as well as a number of STAs 1504-0 to 1504-5. APs 1540-0/1 and/or STAs (1504-0 to -5) can include devices as described herein and/or circuits for executing the various methods described herein.

APs 1540-0/1 can be in communication with one another over a connection 1590, that may be wireless or wired. Over such a connection 1590, APs 1540-0/1 can request for checks for matching MAC addresses 1504-12. Such requests can take the form of any of those described herein. APs 1540-0/1 can store contexts 1550 for associated STAs, as described herein or equivalents.

In some embodiments, STAs (1504-0 to -5) can be part of IoT type devices, including but not limited to, medical devices 1504-0/1, instrumentation devices 1504-2, security devices 1504-3/4 or lighting devices 1504-5. However, such wireless devices are provided by way of example, and any suitable wireless device can benefit from faster and/or lower power reconnection operations as described herein or equivalents. STAs (1508-0 to -5) can associate with a network through AP 1540-0. While a system 1500 can be compatible with an IEEE 802.11 wireless network, alternate embodiments can include any other suitable standard/protocol.

Along these same lines, a system 1500 can include various interconnected networks, including piconets, PANs, LANs, WANs, both private and public, as well as the Internet.

In this way, networks with IoT type devices can detect attacks using device addresses of devices already associated with the network.

Embodiments can include methods, devices and systems that include, by operation of a first wireless device, storing MAC addresses for associated devices in first memory circuits of the first wireless device and receiving a wireless request protocol data unit (PDU) via wireless communication circuits. By operation of controller circuits of the first wireless device, determining if the MAC address of the request PDU matches a stored MAC address. In response to at least the MAC address of the request PDU matching a stored MAC address, ignoring the request PDU or not transmitting buffered data corresponding to a destination of the matching MAC address.

Embodiments can include methods, devices and systems having memory circuits configured to store at least MAC addresses for associated devices; wireless circuits configured to receive and transmit wireless messages according to at least one wireless standard, including receiving a request PDU; and controller circuits. Controller circuits can be configured to determine if a MAC address of the request

PDU matches the MAC address of an associated device stored in the memory circuits, and in response to at least the MAC address of the request PDU matching a stored MAC address, ignoring the request PDU or not transmitting buffered data having a destination of the matching MAC address.

Embodiments can include methods, devices and systems having a wireless device configured to receive and transmit wireless messages according to at least one wireless communication standard, including receiving a request PDU. The wireless device can also be configured to store at least MAC addresses for devices associated with the wireless device; determine if a MAC address of the request PDU matches the MAC address of an associated device, and in response to at least the MAC address of the request PDU matching a stored MAC address, ignoring the request PDU or not transmitting buffered data having a destination of the matching MAC address. A first antenna system compatible with the at least one wireless communication standard.

Methods, devices and systems according to embodiments can include a request PDU that is compatible with at least one IEEE 802.11 wireless standard.

Methods, devices and systems according to embodiments can include storing first additional information corresponding to each stored MAC address for an associated device. In response to a disassociation of an associated device, the MAC address and first additional information corresponding to the disassociated device can be deleted. By operation of the controller circuits, a MAC address and second additional information can be determined for buffered data for transmission from the first wireless device. In response to the second additional information of the buffered data not matching the first information corresponding to the matching MAC addresses, the buffered data may not be transmitted. The first and second additional information can be fields corresponding to a higher level network layer than the MAC address.

Methods, devices and systems according to embodiments can include first additional information including a layer four source port value, and second additional information including a layer four destination port value.

Methods, devices and systems according to embodiments can include maintaining a context for each associated device. Each context including a MAC address, first additional information, a timer, and a buffer location for buffered data. In response to a disassociation of a device, deleting a context for the disassociated device can be deleted from the first memory circuits.

Methods, devices and systems according to embodiments can include a request PDU that includes an association request. In response to at least a MAC address of the request PDU matching a stored MAC address, a response can be returned to a device issuing the request PDU to retry association at a later time and a probe request can be issued with a destination MAC address corresponding to the matching MAC address. In response to receiving an acknowledgement to the probe request, further association requests for the matching MAC address can be ignored.

In response to not receiving an acknowledgement to the probe request, future association requests for the matching MAC address can be processed.

Methods, devices and systems according to embodiments can include, in response to a MAC address of a request PDU not matching any stored MAC addresses, processing the request PDU.

Methods, devices and systems according to embodiments can include a first wireless device that is part of distributed system having at least a second wireless device. In response to the MAC address of request PDU not matching any of the stored MAC addresses, a request can be transmitted to at least the second wireless device to check for other devices associated with the second wireless device having a MAC address that matches that of the request PDU. In response to determining that one of the other associated devices has a matching MAC address, further association requests for the matching MAC address can be ignored. In response to determining that none of the other associated devices has a matching MAC address, future association requests for the matching MAC address can be processed.

Methods, devices and systems according to embodiments can include, by operation of at least the second wireless device, storing MAC addresses for the other associated devices in second memory circuits of the second wireless device and receiving the request to check for other associated devices that match the MAC address of the request PDU. In response to the MAC address of the request PDU matching a MAC address of at least one of the other associated devices, a response to the first wireless device can be returned indicating that one of the other associated devices has a matching MAC address.

Methods, devices and systems according to embodiments can include memory circuits that are further configured to store additional information corresponding to the MAC address of each associated device, and includes at least one buffer configured to store download data for transmission from the device.

Controller circuits can be further configured to scan the download data in the at least one buffer for MAC address values and additional information. In response to determining that stored download data includes the MAC address of an associated device, but not the corresponding additional information, the download data from the buffer may not be transmitted.

Methods, devices and systems according to embodiments can include additional information corresponding to the MAC address of each associated device including a source port address according to a layer four protocol. Additional information for the download data can include a destination port address according to the layer four protocol.

Methods, devices and systems according to embodiments can include controller circuits configured to maintain a context for each associated device. The context for each associated device can include the MAC address for the associated device, at least one source port address, a timer, and an address for a buffer in the memory circuits.

Methods, devices and systems according to embodiments can include controller circuits configured to, in response to the disassociation of one of the associated devices, delete the MAC address for the disassociated device from the memory circuits.

Methods, devices and systems according to embodiments can include a request PDU being an association request (which can include a re-association request). Controller circuits can be configured to, in response to the association request having a MAC address that matches that of an associated device, generate an association response requesting that the association request be re-transmitted at a later time. Controller circuits can also generate a message addressed to the associated device having the matching MAC address. In response to receiving the message from the associated device, a subsequent association request having the matching MAC address can be ignored. Wireless circuits can be configured to transmit the association response and message and receive the response to the message.

Methods, devices and systems according to embodiments can include controller circuits configured to, in response to the message being transmitted by the wireless circuits, starting a timer. In response to the timer exceeding a predetermined value, controller circuits can indicate that a subsequent association request can be processed.

Methods, devices and systems according to embodiments can include wireless device is further configured to store additional information corresponding to the MAC address of each associated device and to store download data for transmission from the wireless device, scan the download data in the at least one buffer for MAC address values and additional information, and, in response to determining that stored download data includes the MAC address of an associated device but not the corresponding additional information, not transmitting the download data.

Methods, devices and systems according to embodiments can include a request PDU including an association request. A wireless device can be a first AP compatible with at least one IEEE 802.11 wireless standard, and can be configured to, in response to at least the MAC address of the request PDU matching the stored

MAC address, transmit a MAC check request to a second AP that includes the MAC address of the request PDU. In response to receiving a first type response from the second AP, transmit a response requesting retransmission of the association request at a later time. In response to receiving a second type response from the second AP and the MAC address of the request PDU not matching a stored MAC address, processing the association request.

Methods, devices and systems according to embodiments can include a second AP is configured to, in response to receiving a check request from a first AP, determine if the MAC address of a request PDU received by the first AP matches the MAC address of any device associated with the second AP. In response to at least the MAC address of the request PDU matching a device associated with the second AP, transmitting the first type response to the first AP. In response to at least the MAC address of the request PDU not matching a device associated with the second AP, transmitting the second type response to the first AP.

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Similarly, it should be appreciated that in the foregoing description of exemplary embodiments of the invention, various features of the invention are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claims require more features than are expressly recited in each claim. Rather, inventive aspects lie in less than all features of a single foregoing disclosed embodiment. Thus, the claims following the detailed description are hereby expressly incorporated into this detailed description, with each claim standing on its own as a separate embodiment of this invention.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method, comprising:
by operation of a first wireless device:
storing media access control (MAC) addresses for devices associated with a wireless network in first memory circuits of the first wireless device,
receiving a wireless request protocol data unit (PDU) via wireless communication circuits,
by operation of controller circuits of the first wireless device,
determining if the MAC address of the request PDU matches a stored MAC address, and
in response to at least the MAC address of the request PDU matching a stored MAC address, ignoring the request PDU or not transmitting buffered data corresponding to the matching MAC address of the request PDU.

2. The method of claim 1, wherein the request PDU is compatible with at least one IEEE 802.11 wireless standard.

3. The method of claim 1, further including:
storing first additional information corresponding to each stored MAC address of each associated device;
in response to a disassociation of one of the associated devices, deleting the MAC address and first additional information corresponding to the disassociated device;
by operation of the controller circuits
determining a MAC address and second additional information for buffered data for transmission from the first wireless device, and
in response to the second additional information of the buffered data not matching the first information corresponding to the matching MAC addresses, not transmitting buffered data, wherein
the first and second additional information are fields corresponding to a higher level network layer than the MAC address.

4. The method of claim 3, wherein:
the first additional information comprises a layer four source port value; and
the second additional information comprises a layer four destination port value.

5. The method of claim 3, further including:
maintaining a context for each associated device, each context comprising
a MAC address,
first additional information, a timer, and
a buffer location for buffered data; and
in response to a disassociation of a device, deleting the context for the disassociated device from the first memory circuits.

6. The method of claim 1, further including:
the request PDU comprises an association request;
in response to at least the MAC address of the request PDU matching a stored MAC address,
returning a response to a device issuing the request PDU to retry association at a later time,
issuing a probe request with a destination MAC address corresponding to the matching MAC address,
in response to receiving an acknowledgement to the probe request, ignoring further association requests for the matching MAC address, and
in response to not receiving an acknowledgement to the probe request, processing a future association request for the matching MAC address.

7. The method of claim 1, further including, in response to the MAC address of request PDU not matching any of the stored MAC addresses, processing the request PDU.

8. The method of claim 1, further including:
the first wireless device is part of distributed system having at least a second wireless device;
in response to the MAC address of request PDU not matching any of the stored MAC addresses,
transmitting a request to at least the second wireless device to check for other devices associated with the second wireless device having a MAC address that matches that of the request PDU, and
in response to determining that one of the other associated devices has a matching MAC address, ignoring further association requests for the matching MAC address, and
in response to determining that none of the other associated devices has a matching MAC address, processing future association requests for the matching MAC address.

9. The method of claim 8, further including:
by operation of at least the second wireless device,
storing MAC addresses for the other devices associated with the second wireless device,
receiving the request to check for other devices associated with the second wireless device,
in response to the MAC address of the request PDU matching a MAC address of at least one of the other associated devices, returning a response to the first wireless device indicating that one of the other associated devices has a matching MAC address.

10. A device, comprising:
memory circuits configured to store at least media access control (MAC) addresses for associated devices;
wireless circuits configured to receive and transmit wireless messages according to at least one wireless standard, including receiving a request protocol data unit (PDU); and
controller circuits configured to
determine if a MAC address of the request PDU matches the MAC address stored in the memory circuits, and
in response to at least the MAC address of the request PDU matching a stored MAC address, ignoring the request PDU or not transmitting buffered data having a destination of the matching MAC address.

11. The device of claim 10, wherein:
the memory circuits are further configured to store additional information corresponding to the MAC address of each associated device, and include at least one buffer configured to store download data for transmission from the device; and
the controller circuits are further configured to
scan the download data in the at least one buffer for MAC address values and additional information, and
in response to determining that stored download data includes the MAC address of an associated device, but not the corresponding additional information, not transmitting the download data from the buffer.

12. The device of claim 11, wherein:
the additional information corresponding to the MAC address of each associated device comprises a source port address according to a layer four protocol; and
the additional information for the download data comprises a destination port address according to the layer four protocol.

13. The device of claim 10, wherein:
the controller circuits are configured to maintain a context for each associated device, the context for each associated device comprising,
the MAC address for the associated device,
at least one source port address,
a timer, and
an address for a buffer in the memory circuits.

14. The device of claim 10, wherein:
the controller circuits are configured to, in response to the disassociation of one of the associated devices, delete the MAC address for the disassociated device from the memory circuits.

15. The device of claim 10, wherein:
the request PDU comprises an association request;
the controller circuits are configured to,
in response to the association request having a MAC address that matches that of an associated device, generate an association response requesting that the association request be re-transmitted at a later time,
generate a message addressed to the associated device having the matching MAC address, and
in response to receiving a response to the message from the associated device, ignoring a subsequent association request having the matching MAC address; and
the wireless circuits are configured to transmit the association response and message and receive the response to the message.

16. The device of claim 15, wherein:
the controller circuits are configured to
in response to the message being transmitted by the wireless circuits, starting a timer, and
in response to the timer exceeding a predetermined value, indicating a subsequent association request can be processed.

17. A system, comprising:
a wireless device configured to
receive and transmit wireless messages according to at least one wireless communication standard, including receiving a request protocol data unit (PDU);
store at least media access control (MAC) addresses for devices associated with the wireless device;
determine if a MAC address of the request PDU matches the MAC address of an associated device, and
in response to at least the MAC address of the request PDU matching a stored MAC address, ignoring the request PDU or not transmitting buffered data having a destination of the matching MAC address; and
a first antenna system compatible with the at least one wireless communication standard.

18. The system of claim 17, wherein:
the wireless device is further configured to
store additional information corresponding to the MAC address of each associated device and to store download data for transmission from the wireless device,
scan the download data for MAC address values and additional information, and
in response to determining that stored download data includes the MAC address of an associated device, but not the corresponding additional information, not transmitting the download data.

19. The system of claim 17, further including:
the request PDU comprises an association request; and
the wireless device comprises a first access point device (AP) compatible with at least one IEEE 802.11 wireless standard, and is configured to,
in response to at least the MAC address of the request PDU matching the stored MAC address, transmit a MAC check request to a second AP, the check request including the MAC address of the request PDU,
in response to receiving a first type response from the second AP, transmit a response requesting retransmission of the association request at a later time, and
in response to receiving a second type response from the second AP and the MAC address of the request PDU not matching a stored MAC address, processing the association request.

20. The system of claim 19, further including:
the second AP is configured to
in response to receiving the check request, determine if the MAC address of the request PDU matches the MAC address of another device associated with the second AP,
in response to at least the MAC address of the request PDU matching another device associated with the second AP, transmitting the first type response, and
in response to at least the MAC address of the request PDU not matching a device associated with the second AP, transmitting the second type response.
